(19) United States
(12) Patent Application Publication
(10) Pub. No.: US 2024/0287681 A1
(43) Pub. Date: Aug. 29, 2024

(54) Improved Activation Agent for Manganese Phosphating Processes

(71) Applicant: CHEMETALL GMBH, Frankfurt am Main (DE)

(72) Inventor: Ralf SCHNEIDER, Frankfurt am Main (DE)

(21) Appl. No.: 18/003,662

(22) PCT Filed: Jun. 25, 2021
(86) PCT No.: PCT/EP2021/067526

§ 371 Date: Dec. 28, 2022

(30) Foreign Application Priority Data
Jul. 1, 2020 (EP) 20183417.3

(51) Int. Cl. C23C 22/18

(52) U.S. Cl. CPC C23C 22/18

(57) ABSTRACT

Disclosed herein is an alkaline aqueous activation agent for manganese phosphating processes, which includes a) nanoscale manganese phosphate particles in dispersed form, and b) at least one dispersion agent selected from the group consisting of homo- and copolymers containing at least one monomeric unit having at least one carboxylic acid salt group. Further disclosed herein is a method for producing said activation agent, an improved manganese phosphating process making use of the activation agent and an accordingly phosphatized metallic substrate, especially a steel substrate.

### CROSS-REFERENCE TO RELATED APPLICATIONS

This application is a U.S. National Phase application of International Patent Application No. PCT/EP2021/067526, filed Jun. 25, 2021, which claims priority to European Patent Application No. 20183417.3, filed Jul. 1, 2020, each of which is hereby incorporated by reference herein.

### DESCRIPTION

The present invention refers to an improved activation agent for manganese phosphating processes as well as to a method for its production, an improved manganese phosphating process making use of said activation agent and an accordingly phosphatized metallic substrate, especially a steel substrate.

Above all, acidic aqueous manganese phosphate systems are used to phosphatize steel substrates, especially engine parts like e.g. engine transmissions or pipe couplings in oil fields. The phosphatized substrates do not only exhibit an improved corrosion resistance but a lower sliding friction as well. Beside manganese and phosphate ions, manganese phosphate systems preferably comprise iron(II) and/or nickel ions in dissolved form.

To allow the formation of a crystalline phosphate layer, e.g. consisting of Hureaulite, on the surface of the substrate to be coated, said surface first needs to be activated, i.e. phosphate crystals have to be deposited as crystallization nuclei. This is achieved by means of applying an according activation agent to the surface.

Within the production of activation agents for manganese phosphating processes, dry manganese phosphate is usually ground by means of a dry mill in order to obtain manganese phosphate powder which is then dispersed into an alkaline aqueous composition.

However, activation agents obtained this way have the disadvantage that, without continuous stirring, the manganese particles settle down and cannot activate anymore. Because of this tendency to settle down, there is always the risk of manganese phosphate waste precipitating on the substrate's surface leading to an insufficient adherence and homogeneity of the subsequently deposited phosphate layer.

Furthermore, such activation agents need to be applied in rather high concentration as, due to a particle size of several micrometers (typical d₅₀ value of ca. 3 μm), the activation is not very efficient. For the same reason, the subsequent manganese phosphating process needs to be conducted at relatively high temperatures, typically in the range of from 80 to 90° C.

Hence, it has been the problem underlying the present invention to provide an improved activation agent for manganese phosphating processes avoiding the drawbacks of the prior art agents as set forth above.

This problem has been solved by an activation agent according to claim 1, namely by an alkaline aqueous activation agent which comprises
a) nanoscale manganese phosphate particles in dispersed form, and
b) at least one dispersion agent selected from the group consisting of homo- and copolymers containing at least one monomeric unit having at least one carboxylic acid salt group.

By using at least one dispersion agent according to b), the viscosity of the corresponding concentrate for producing said activation agent is suitable in such a way that it is neither to high nor to low, since a viscosity being too high would cause problems in removing the concentrate from its storage container, whereas, a viscosity being too low would lead to an irreversible phase separation after approximately two weeks of storage.

### Definitions

For the present invention, “aqueous composition” means that more than 35 weight percent of the composition is water, wherein preferably deionized water used.

“Nanoscale ( . . . ) particles” is to be understood in such a way that the d₉₀ value of the particle size distribution is less than 1.0 μm.

“In dispersed form” means that the particles are distributed in the continuous aqueous phase, in such a way that a dispersion is obtained and the particles will not settle if the composition is left undisturbed for a prolonged period of time, i.e. said heterogeneous mixture is a colloid, or, in case the particles partially settle, a flowable dispersion can be restored by shortly shaking up the composition.

Accordingly, a “dispersion agent” means a compound stabilizing the distribution of the particles in the continuous aqueous phase in such a way that a colloid is obtained or, in case the particles partially settle after a prolonged period of time, a flowable dispersion can be restored by shortly shaking up the composition.

Herein, “wt.-%” is the abbreviation for weight percent, i.e. the mass of the according compound divided by the mass of the entire composition.

The term “carboxylic acid salt group” means a carboxylic acid group in its deprotonated, i.e. neutralized form.

Herein, “(meth)acrylic” is the abbreviation for acrylic, methacrylic or a mixture of acrylic and methacrylic. Correspondingly, a “copolymer of (meth)acrylic acid” means a polymer also containing other monomeric units not originating from (meth)acrylic acid.

The nanoscale manganese phosphate particles preferably exhibit a particle size distribution with a d₉₀ value of less than 0.8 μm, more preferably of less than 0.7 μm, more preferably of less than 0.6 μm, and most preferably of less than 0.5 μm.

At that, the d₅₀ value of the particle size distribution is preferably less than 0.5 μm, more preferably less than 0.4 μm, and most preferably less than 0.3 μm, whereas, the d₁₀ value is preferably less than 0.3 μm and more preferably less than 0.2 μm.

The particle size distribution including the d₁₀, d₅₀ and d₉₀ value may be determined by means of a Mastersizer 2000 (Malvern Instruments, United Kingdom) and according to the manufacturer's operating manual.

Preferably at least 35 wt.-%, more preferably at least 50 wt.-% and even more preferably at least 65 wt.-% of the nanoscale manganese phosphate particles are crystalline. The percentage of such nanocrystalline particles may be determined via wide angel X-ray scattering (WAXS).

In the alkaline aqueous activation agent, the concentration of the nanoscale manganese phosphate particles preferably lies in the range of from 1.0 to 8.0·10⁻³ wt.-%, more preferably in the range of from 2.0 to 7.0·10⁻³ wt.-%, and most preferably in the range of from 2.5 to 6.5·10⁻³ wt.-%.

The prior art manganese phosphate powder obtained by dry grinding of manganese phosphate requires a concentration of ca. 0.1 to 0.3 wt.-% in the dispersion. Compared to this, the concentration of the dispersed nanoscale manganese phosphate particles according to the present invention is ca. 100-fold lower demonstrating the extreme efficiency of the latter.

The at least one dispersion agent is preferably selected from the group consisting of homo- and copolymers containing at least one monomeric unit having at least one carboxylic acid salt group, wherein said at least one monomeric unit makes up at least 35 mol-%, more preferably at least 50 mol-%, even more preferably at least 65 mol-% and most preferably at least 80 mol-% of the monomeric units of the according copolymer.

Preferably, the at least one dispersion agent comprises at least one salt of at least one homo- or copolymer of (meth)acrylic acid, more preferably at least one salt of at least one homo- or copolymer of acrylic acid. Preferred homo- and copolymers are linear. Preferred copolymers are such with maleic acid. Preferred salts are sodium or potassium salts, especially preferred are sodium salts.

According to a preferred embodiment, the at least one dispersion agent comprises, preferably is the sodium salt of an acrylic acid homopolymer and/or a copolymer of acrylic acid and maleic acid.

Aron A 6020 (Toagosei, Japan) or Dispex® N40 (Ciba, Switzerland) are especially suitable and commercially available dispersion agents.

The overall concentration of the at least one dispersion agent in the aqueous alkaline activation agent preferably lies above 0.04·10⁻³, more preferably 0.12·10⁻³ and even more preferably 0.16·10⁻³ wt.-%. In case the concentration is below 0.04·10⁻³ wt.-%, it is possible that not all nanoscale manganese phosphate particles are present in dispersed form. However, a high concentration of the dispersion agent possibly results in a lower storage stability of the alkaline activation agent, inter alia due to a higher susceptibility for bacterial contamination. Thus, the overall concentration of the at least one dispersion agent preferably lies below 0.80·10⁻³, more preferably 0.64·10⁻³ and even more preferably 0.48·10⁻³ wt.-%.

The overall concentration of the at least one dispersion agent more preferably lies in the range of from 0.04 to 0.80-10⁻³ wt.-%, more preferably in the range of from 0.12 to 0.64·10⁻³ wt.-%, even more preferably in the range of from 0.16 to 0.48·10⁻³ wt.-% and most preferably in the range of from 0.18 to 0.42·10⁻³ wt.-%.

In terms of the concentrations in wt.-% in the activation agent, the nanoscale manganese phosphate particles and the at least on dispersion agent preferably exhibit a ratio in the range of from 1.2:1 to 200:1, more preferably in the range of from 3:1 to 60:1 and even more preferably in the range of from 5.2:1 to 41:1.

Besides components a) and b), i.e. the nanoscale manganese phosphate particles and the at least one dispersion agent, the alkaline aqueous activation agent may comprise further advantageous components, in particular at least one additive. Especially suitable additives are such selected from the group consisting of biocides and agents for adjusting the pH value including buffer systems. Moreover, it may be advantageous to add at least one defoamer.

Preferably, the activation agent comprises c) at least one biocide, the overall concentration of which preferably lies in the range of from 0.1 to 0.5 wt.-%. A preferred biocide is Acticide® MBS 50 (Thor, Germany).

The pH value of the activation agent is above 7.0 and preferably lies in the range of from 7.5 to 10.0, more preferably in the range of from 8.5 to 10.0.

Preferably, the activation agent comprises c) at least one buffer system.

The present invention also relates to a method for producing an alkaline aqueous activation agent, wherein a mixture comprising water and
a) manganese phosphate, and
b) at least one dispersion agent selected from the group consisting of homo- and copolymers containing at least one monomeric unit having at least one carboxylic acid salt group
   is wet ground in a bead mill, preferably in an agitator bead mill, until an aqueous concentrate containing nanoscale manganese phosphate particles in dispersed form is obtained, from which by dilution with water, preferably by a factor in the range of from 1:4,000 to 1:12,000 referring to volume, and, if necessary, by addition of at least one agent for adjusting the pH value an alkaline aqueous activation agent is obtained.

The concentration of manganese phosphate a), which preferably is Hureaulite, in the mixture to be ground preferably lies in the range of from 25 to 35 wt.-%, which is advantageous in terms of a suitable viscosity of the mixture to be ground.

By using at least one dispersion agent according to b), the viscosity of the mixture to be ground is sufficiently low, such that, during the grinding process, the mobility of the beads inside the grinding chamber and the throughput of material are high enough to obtain nanoscale manganese phosphate particles in dispersed form.

The at least one dispersion agent is preferably selected from the group consisting of homo- and copolymers containing at least one monomeric unit having at least one carboxylic acid salt group, wherein said at least one monomeric unit makes up at least 35 mol-%, more preferably at least 50 mol-%, even more preferably at least 65 mol-% and most preferably at least 80 mol-% of the monomeric units of the according copolymer.

Preferably, the at least one dispersion agent in the mixture to be ground comprises at least one salt of at least one homo- or copolymer of (meth)acrylic acid, more preferably at least one salt of at least one homo- or copolymer of acrylic acid. Preferred homo- and copolymers are linear. Preferred copolymers are such with maleic acid. Preferred salts are sodium or potassium salts, especially preferred are sodium salts.

According to a preferred embodiment, the at least one dispersion agent comprises, preferably is the sodium salt of an acrylic acid homopolymer and/or a copolymer of acrylic acid and maleic acid.

Aron A 6020 (Toagosei, Japan) or Dispex® N40 (Ciba, Switzerland) are especially suitable and commercially available dispersion agents.

The overall concentration of the at least one dispersion agent in the mixture to be ground preferably lies in the range of from 1 to 10 wt.-%, more preferably in the range of from 3 to 8 wt.-% and even more preferably in the range of from 4 to 6 wt.-%, which is advantageous in terms of a suitable viscosity of the mixture to be ground.

A bead mill contains a multitude of beads filled inside a grinding chamber. In case of agitator bead mills, grinding is supported by means of an agitator shaft located inside the grinding chamber. In particular, the agitator shaft is a cylinder having rows of knobs on its surface (e.g. Grinding Systems MiniFer, NEOS, ZETA® and MACRO, Netzsch, Germany) or a rotor having several parallel discs (e.g. DYNA®-MILL, WAB, Switzerland).

In case the volume of beads is more than 88% of the total volume of the mixture filled into the grinding chamber, preferably more than 92%, and the speed of rotation of the mill during the grinding process is less than 3,400 rpm, preferably less than 3,200 rpm, activation agents with especially suitable viscosity as well as particularly small particle sizes are obtained.

After grinding, at least one further component c) may be added to the mixture, in particular at least one additive. Especially suitable additives are such selected from the group consisting of biocides and agents for adjusting the pH value including buffer systems. Moreover, it may be advantageous to add at least one defoamer.

As for the method for producing the activation agent, further preferred features and embodiments can be taken from the inventive activation agent as described herein above.

The present invention also relates to an aqueous concentrate for producing the inventive alkaline aqueous activation agent, wherein the latter may be obtained from the concentrate by dilution with water, preferably by a factor in the range of from 1:4,000 to 1:12,000 referring to volume, and, if necessary, by addition of at least one agent for adjusting the pH value.

The present invention is directed to an improved manganese phosphating process as well, namely to a manganese phosphating process comprising the following steps:
i) Bringing a preferably cleaned and/or pickled metallic substrate, especially a steel substrate, into contact with the alkaline aqueous activation agent according to the present invention,
ii) optionally rinsing the metallic substrate
iii) bringing the metallic substrate into contact with an acidic aqueous manganese phosphate system comprising manganese, phosphate, and preferably iron(II) and/or nickel ions in dissolved form
iv) optionally rinsing the metallic substrate,
v) drying the metallic substrate, and
vi) optionally coating the metallic substrate with at least one oil, emulsion and/or polymer, preferably for the purpose of corrosion protection.

In comparison with a prior art manganese phosphating process making use of manganese phosphate powder obtained by dry grinding, the manganese phosphating process according to the present invention exhibits
less energy costs
less consumption of activation agent and manganese phosphating system, and
less waste in activation bath and less scale in phosphating bath.

The metallic substrate preferably is a steel substrate, especially an engine part like e.g. an engine transmission or a pipe coupling for the use in oil fields. In such cases, not only an improved corrosion resistance but also a lower sliding friction is important.

In case the substrate is cleaned before performing step i), a silicate-free alkaline cleaner is preferably used for cleaning. Moreover, cleaning is performed at a temperature preferably in the range of from 50 to 85° C. and for a duration of 10 min for example.

In case the substrate is pickled before performing step i), a mineral acid like e.g. phosphoric acid is preferably used for pickling.

Step i) of the inventive method is preferably conducted by immersion of the substrate into the activation agent preferably at room temperature and for a duration of 1 min for example.

In case rinsing step ii) is conducted, it is preferably conducted by immersion of the substrate into cold tap water for a duration of 1 min for example. The same applies to optional rinsing step iv).

Due to the use of the inventive activation agent, step iii) of the inventive process may be conducted at a temperature of below 80° C., preferably of below 75° C. or even more preferably of below 65° C. Step iii) is preferably conducted by immersion of the substrate into the activation agent for a duration of 10 min for example.

The manganese phosphate system in step iii) preferably contains nitroguanidine as phosphating accelerator, the concentration of which preferably lies the range of from 0.5 to 3 g/l, more preferably in the range of from 1 to 2 g/l. The addition of nitroguanidine contributes to a lower temperature in step iii) as well.

In the manganese phosphate system, the ratio of Total Acid to Free Acid preferably lies in the range of from 5 to 15, more preferably in the range of from 8 to 12. At this, the Total Acid of the manganese phosphate system is determined by the following procedure:

5 ml of phosphating bath are pipetted into an Erlenmeyer flask, diluted with approx. 50 ml of distilled water and provided with 10 to 15 drops of a phenolphthalein PH indicator. Then, the sample is titrated with 0.1 M sodium hydroxide solution until its color changes to red, wherein the consumed volume of hydroxide solution divided by ml and multiplied by 2 is the Total Acid of the phosphating bath.

The Free Acid is determined as follows:

5 ml of phosphating bath are pipetted into an Erlenmeyer flask, diluted with approx. 50 ml of distilled water and provided with 1 drop of a dimethyl yellow pH indicator. Then, the sample is titrated with 0.1 M sodium hydroxide solution until its color changes to yellow, wherein the consumed volume of hydroxide solution divided by ml and multiplied by 2 is the Free Acid of the phosphating bath.

Choosing the specific ratio of Total Acid to Free Acid also helps to lower the temperature in step iii).

Step v) is preferably conducted by means of an oven at a temperature preferably in the range of from 100 to 120° C. and for a duration preferably in the range of from 5 to 20 minutes or by means of compressed air.

As for the manganese phosphating process, further preferred features and embodiments can be taken from the inventive activation agent as described herein above.

Last not least, the present invention also refers to a phosphatized metallic substrate, especially a steel substrate, obtainable by the manganese phosphating process according to the present invention. In comparison with a prior art phosphate layer obtained by a prior art phosphating process as described herein above, the phosphate layer obtained by the inventive process
i) is more homogenous
ii) has a reduced coating weight, and
iii) consists of much finer crystals.

Due to this, an accordingly phosphatized surface exhibits an improved performance, especially in terms of corrosion resistance and low sliding friction.

In the following, the present invention will be further explained by means of inventive and comparative examples, whereby the scope of the invention should not be restricted.

### EXAMPLES

### A) Grinding Parameters:

Mixtures consisting of water, 30 wt.-% of manganese phosphate (Hureaulite) as well as 5 wt.-% of Aron A 6020 (Toagosei, Japan), which are 2 wt.-% referring to the polymer, were wet ground in a MiniFer agitator bead mill (Netzsch, Germany) for 4 hours by means of zirconium oxide beads having a diameter of from 0.5 to 0.7 mm, wherein, in each case, the total volume of the according mixture and the zirconium oxide beads was 160 ml and the throughput of material during the grinding process was 250 ml/min.

The grinding parameters volume of beads, speed of rotation, pressure and temperature were varied as shown in the following Tab. 1:

TABLE 1

| | Volume of | Speed of | | |
|---|---|---|---|---|
| | Beads | Rotation | Pressure | Temperature*** |
| Example | [ml]/[%]* | [rpm]** | [bar] | [° C.] |
| E1 | 130/81 | 2,400 | 0.3 | 30 |
| E2 | 140/88 | 2,400 | 0.3 | 30 |
| E3 | 150/94 | 2,400 | 0.4 | 30 to 40 |
| E4 | 130/81 | 3,000 | 0.4 | 30 to 40 |
| E5 | 140/88 | 3,000 | 0.4 | 30 to 40 |
| E6 | 150/94 | 3,000 | 0.5 | 30 to 40 |
| E7 | 130/81 | 3,400 | 0.5 | 30 to 40 |
| E8 | 140/88 | 3,400 | 0.5 | 30 to 40 |
| E9 | 150/94 | 3,400 | 0.5 | 30 to 40 |

*Share of beads in total volume, i.e. volume of beads and volume of mixtures as described above;
**rpm = revolutions per minute;
***If, due to friction, the temperature increased to more than 30° C., a water cooling was started automatically.

All combinations of parameters applied in examples E1 to E9 lead to concentrates with suitable viscosity and, as determined by means of a Mastersizer 2000 (Malvern Instruments, United Kingdom) according to the manufacturer's operating manual, a distribution of nanoscale manganese phosphate particles.

However, in terms of viscosity and small particle size, the combination of parameters applied in examples E3 and E6 lead to the best results.

### B) Dispersion Agents:

Mixtures consisting of water, 30 wt.-% of manganese phosphate (Hureaulite) as well as 5 wt.-% of different dispersion agent products, which in each case are approx. 2 wt.-% referring to the polymers, were wet ground in a MiniFer agitator bead mill (Netzsch, Germany) for 4 hours (at 94% volume of beads and 3,000 rpm speed of rotation) by means of zirconium oxide beads having a diameter of from 0.5 to 0.7 mm, wherein, in each case, the overall volume of the according mixture and the zirconium oxide beads was 160 ml. The concentrates obtained were then diluted with water by a factor of 1:5,000 (referring to volume) and adjusted to a pH value of 9.5.

The following Tab. 2 shows the dispersion agent products applied and the results obtained for the corresponding concentrates and activation agents in terms of sufficiently low viscosity as well as compatibility with a subsequent manganese phosphating process, respectively. As there is always a certain carryover into the phosphating bath, the activation agent must not disturb the phosphating bath, i.e. needs to be compatible with the phosphating process.

TABLE 2

| (Comparative) | | | Compatibility |
|---|---|---|---|
| Example | Dispersion Agent | Viscosity | (Phosphating) |
| CE1 | Disperbyk 2080 | − | n.d. |
| | (BYK Chemie, Germany) | | |
| CE2 | Edaplan 492 | + | − |
| | (Münzing, Germany) | | |
| E10 | Dispex ® AA 4140 | + | + |
| | (BASF, Germany) | | |
| E11 | Dispex ® N40 | + | + |
| | (Ciba, Switzerland) | | |
| E12 | Aron A 6020 | + | + |
| | (Toagosei, Japan) | | |

+ = requirements fulfilled;
− = requirements not fulfilled;
n.d. = not determined due to unsuitable viscosity

As for Disperbyk 2080 (comparative example CE1), the viscosity of the obtained concentrate was too high leading to problems in the grinding process and in removing the concentrate from its storage container, whereas, in case of Edaplan 492 (comparative example CE2), the manganese phosphating bath was completely disturbed due to the carryover of the activation agent.

In contrast to that, the use of Dispex® AA 4140, Dispex® N40 as well as of Aron A 6020 resulted in concentrates with sufficiently low viscosity and activation agents being compatible with a subsequent phosphating process (examples E10 to E13).

### C) Particle Size Analysis:

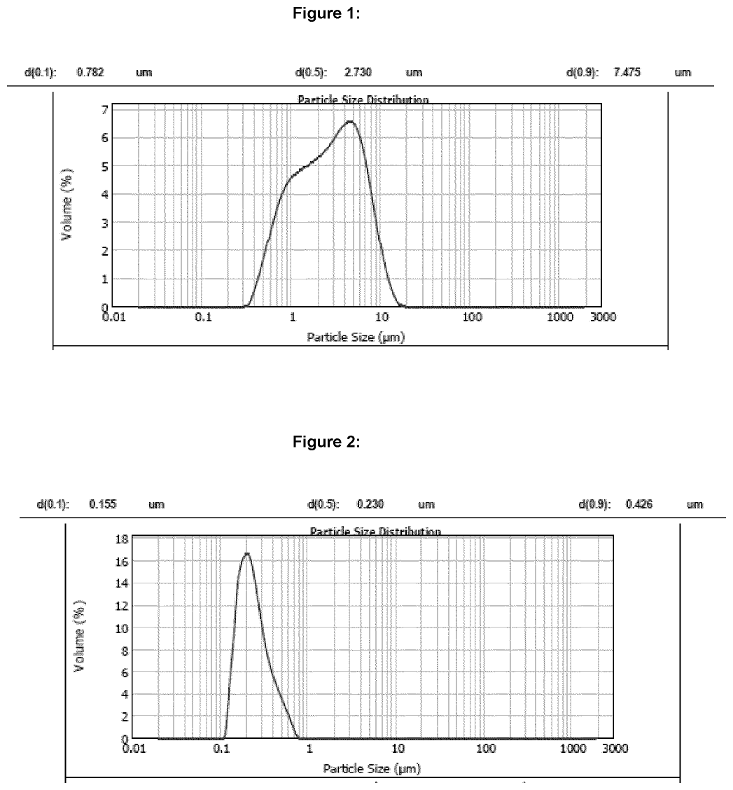

The particle size distribution of manganese phosphate (Hureaulite) was determined by means of a Mastersizer 2000 (Malvern Instruments, United Kingdom) according to the manufacturer's operating manual before (FIG. 1) and after (FIG. 2) wet grinding according to the procedure described for examples E3 or E6 (see above).

As one may easily derive when comparing FIG. 1 and FIG. 2, the particle size distribution after wet grinding is significantly shifted to lower particle sizes entirely below 1 μm, i.e. nanoscale particles.

### D) XPS and SEM Surface Analysis:

Test panels made of cold rolled steel (CRS) and hot rolled steel (HRS) were treated as follows:

The panels were degreased by immersion into a solution containing 50 g/l of an alkaline cleaner (GC S5176, Chemetall, Germany) for 10 min at 65° C. and, then, rinsed by immersion into cold tap water for 1 min.

Subsequently, activation was performed by immersion into an aqueous dispersion of 6.0·10⁻³ wt.-% of wet-ground manganese phosphate (Hureaulite) as well as 5 wt.-% of Aron A 6020 (Toagosei, Japan) having a pH value of 9.5 for 1 min at room temperature and, then, phosphating by immersion into an acidic aqueous solution of manganese phosphate for 10 min at 78° C.

After subsequent rinsing by immersion into cold tap water for 1 min, the panels were dried by using pressed air.

Then, the phosphate coating weight was determined gravimetrically, i.e. by means of differential weighing, whereas, the structure of the surface was visualized via a SEM (scanning electron microscope).

The average phosphate coating weight was 5 to 10 g/m², which is significantly lower than the coating weights obtained after activation with the same concentration of dispersed dry-ground manganese phosphate (prior art), which typically lie above 15 g/m².

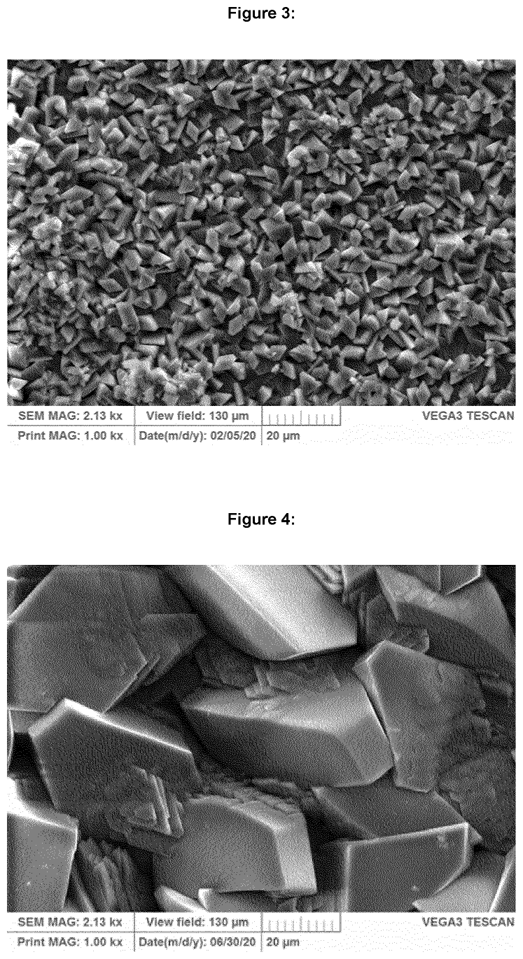

Compared to prior art, the phosphate coatings were more homogenous and consisted of much finer crystals as can be taken from FIG. 3.

1. An alkaline aqueous activation agent for manganese phosphating processes, characterized in that the alkaline aqueous activation agent comprises
a) nanoscale manganese phosphate particles in dispersed form, and
b) at least one dispersion agent selected from the group consisting of homo- and copolymers containing at least one monomeric unit having at least one carboxylic acid salt group.

2. The alkaline aqueous activation agent according to claim 1, characterized in that the nanoscale manganese phosphate particles exhibit a particle size distribution with a don value of less than 0.7 μm.

3. The alkaline aqueous activation agent according to claim 1 characterized in that the concentration of the nanoscale manganese phosphate particles lies in the range of from 1.0 to 8.0·10⁻³ wt.-%.

4. The alkaline aqueous activation agent according to claim 1, characterized in that the at least one dispersion agent comprises at least one salt of at least one homo- or copolymer of (meth)acrylic acid.

5. The alkaline aqueous activation agent according to claim 1, characterized in that the overall concentration of the at least one dispersion agent lies in the range of from 0.04 to 0.80·10⁻³ wt.-%.

6. The alkaline aqueous activation agent according to claim 1, characterized in that the alkaline aqueous activation agent comprises c) at least one biocide.

7. The alkaline aqueous activation agent according to claim 1, characterized in that a pH value of the alkaline aqueous activation agent lies in the range of from 7.5 to 10.0.

8. A method for producing an alkaline aqueous activation agent according to claim 1, characterized in that a mixture comprising water and
a) manganese phosphate, and
b) at least one dispersion agent selected from the group consisting of homo- and copolymers containing at least one monomeric unit having at least one carboxylic acid salt group
is wet ground in a bead mill until an aqueous concentrate containing nanoscale manganese phosphate particles in dispersed form is obtained, from which by dilution with water and, if necessary, by addition of at least one agent for adjusting the pH value an alkaline aqueous activation agent is obtained.

9. The method according to claim 8, characterized in that the bead mill is an agitator bead mill.

10. The method according to claim 8, characterized in that the at least one dispersion agent comprises at least one salt of at least one homo- or copolymer of (meth)acrylic acid.

11. The method according to claim 8, characterized in that the overall concentration of the at least one dispersion agent lies in the range of from 1 to 10 wt.-%.

12. An aqueous concentrate for producing an alkaline aqueous activation agent according to claim 1, characterized in that the activation agent is obtainable from the concentrate by dilution with water and, if necessary, by addition of at least one agent for adjusting the pH value.

13. A manganese phosphating process, characterized in that the manganese phosphating process comprises the following steps:
i) Bringing a metallic substrate into contact with the activation agent according to claim 1,
ii) optionally rinsing the metallic substrate,
iii) bringing the metallic substrate into contact with an acidic aqueous manganese phosphate system comprising manganese and phosphate,
iv) optionally rinsing the metallic substrate,
v) drying the metallic substrate, and
vi) optionally coating the metallic substrate with at least one oil, emulsion and/or polymer.

14. The manganese phosphating process according to claim 13, characterized in that the manganese phosphate system in step iii) contains nitroguanidine as phosphating accelerator.

15. The manganese phosphating process according to claim 13, characterized in that in the manganese phosphate system in step iii) the ratio of Total Acid to Free Acid lies in the range of from 5 to 15.

16. A phosphatized metallic substrate, characterized in that it is obtained by a phosphating process according to claim 13.

17. The alkaline aqueous activation agent according to claim 1, characterized in that the nanoscale manganese phosphate particles exhibit a particle size distribution with a d₉₀ value of less than 0.5 μm.

18. The alkaline aqueous activation agent according to claim 1 characterized in that the concentration of the nanoscale manganese phosphate particles lies in the range of from 2.0 to 7.0 ·10⁻³ wt.-%.

19. The alkaline aqueous activation agent according to claim 1, characterized in that the overall concentration of the at least one dispersion agent lies in the range of from 0.12 to 0.64·10⁻³ wt.-%.

20. The alkaline aqueous activation agent according to claim 1, characterized in that it comprises c) at least one biocide, the overall concentration of which lies in the range of from 0.1 to 0.5 wt.-%.
